(19) United States
(12) Patent Application Publication
(10) Pub. No.: US 2005/0196517 A1
(43) Pub. Date: Sep. 8, 2005

(54) Edible product having discrete regions with different heats of solution

(75) Inventors: Tami L. Hodanko, Praha 8-Kobylisy (CZ); Kevin J. Stanton, Califon, NJ (US); Wang Yanjing, Beijing (CN); Zhao Wenling, Beijing (CN); Yu Yang, Beijing (CN); Xiao Xia, Beijing (CN); Michael E. Webster, Blairstown, NJ (US); Andrew G. Johnston, Lancs (GB)

Correspondence Address: FITZPATRICK CELLA HARPER & SCINTO, 30 ROCKEFELLER PLAZA, NEW YORK, NY, 10112, US

(73) Assignee: MARS, INCORPORATED, McLean, VA (US)

(21) Appl. No.: 11/058,492

(22) Filed: Feb. 14, 2005

Related U.S. Application Data
(63) Continuation-in-part of application No. PCT/CN04/00938, filed on Aug. 12, 2003.

(51) Int. Cl. A23L 1/05

(52) U.S. Cl. 426/660

(57) ABSTRACT

An edible product, such as a hard candy or pressed tablet, is provided with two distinct and discrete regions having different heats of solution, so that a warming and cooling mouthfeel are produced simultaneously on the tongue or in the oral cavity when the product is consumed.

### CROSS REFERENCE TO RELATED APPLICATION

This application is a continuation-in-part of international application no. PCT/CN2004/000938, filed Aug. 12, 2003, which designates the United States of America and is incorporated by reference.

### BACKGROUND OF THE INVENTION

1. Field of the Invention

The invention relates to edible products, such as a hard candy or pressed tablet confectionery. The edible product is provided with at least first and second discrete regions which have different heats of solution to create a simultaneous cooling and warming mouthfeel.

2. Description of the Related Art

Multi-component confectionery products are known in the food industry. In particular, products having separate regions with different flavor profiles are known.

United States Patent Application Publication No. 2003/0118628 A1 discloses a confectionery, including a hard candy, having discrete regions, with each region providing a different sensory effect. However, that application does not teach that the discrete regions may be made of different sugar bases or sugarless bases, nor does it teach that a difference in heats of solution between two discrete regions may be used to produce a simultaneous cooling and warming mouthfeel in the product.

Heretofore, no edible product known to the applicants has provided a discernible sensory mouthfeel of cooling and warming at the same time when the product is consumed. In particular, there has not been an edible product that utilizes a difference in the heat of solution between two discrete regions of the product to bring about a sensation of cooling and warming, i.e., as a result of a physical, as opposed to a physiological, mechanism.

### SUMMARY OF THE INVENTION

In one aspect, the invention is a rigid edible product, such as a hard candy or pressed tablet, comprising at least a first region and a second region. The first region and the second region each have a surface on the exterior of the product such that they are both contacted substantially simultaneously by the tongue or oral cavity when the product is consumed. The first and second regions are discrete and sufficiently large that they each provide a discernible sensory mouthfeel of warming or cooling, there being a difference of the heat of solution between the first region and the second region of 40 kJ/kg or greater, such that one region provides a warming mouthfeel and the other region provides a cooling mouthfeel that are perceived simultaneously on the tongue or in the oral cavity.

In another aspect, the present invention provides a confectionery product comprising an integrated body portion, which includes at least two distinct and discrete regions, wherein different regions of said distinct and discrete regions respectively contain different physiologically acceptable sweetener bases, i.e., one region of said distinct and discrete regions contains a sweetener base that is different from that contained in an adjacent region or adjacent regions. Preferably, at least one region of said distinct and discrete regions respectively consists essentially of a sugar free sweetener base, selected from the group consisting of isomalt, xylitol, mannitol, lactitol, maltitol and sorbitol. These materials may be either crystalline, in which case they have a negative heat of solution or (in some cases, such as isomalt) amorphous, in which case they have substantially zero heat of solution.

In another aspect, the invention is an edible product kit, comprising a plurality of separate edible pieces. The plurality of edible pieces is packaged so that at least a first piece and a second piece are contacted substantially simultaneously in the oral cavity, and the first piece and second piece comprise different sweetener bases, there being a difference in the heats of solution between the first piece and the second piece of 40 kJ/kg or greater.

Because the confectionery product according to the invention comprises at least two distinct and discrete regions, which respectively contain different physiologically acceptable sweetener bases, and those different sweeteners respectively have different chemical and physical properties, in particular a different heat of solution, the respective regions have a mouthfeel of warming and cooling.

A surprising aspect of the present invention is that the confectionery product provides both cool and warm sensations without having discrete regions of positive and negative heats of solution respectively. It has been found that a crystalline material, which has a negative heat of solution, will be perceived as cool, while an adjacent region made of an amorphous material will feel warm, even though the amorphous region has no heat of solution. Other objects, advantages and novel features of the invention will become more apparent from the following detailed description.

### BRIEF DESCRIPTION OF THE DRAWINGS

FIG. 1 is a chart showing the heats of solution of various sugar bases and sugarless bases

### DETAILED DESCRIPTION OF THE PREFERRED EMBODIMENT

A “rigid edible product” as that term is used herein, means a solid edible product that retains its shape while it is consumed, gradually being dissolved in the oral cavity. Non limiting examples include hard candy and pressed tablets.

In the discussion that follows, all ratios and percentages are by weight of finished confectionery product unless otherwise indicated.

An important feature of the invention is that the heat of solution of the first region and the heat of solution of the second region differ by at least about 40 kJ/kg to produce a simultaneous cooling and warming mouthfeel.

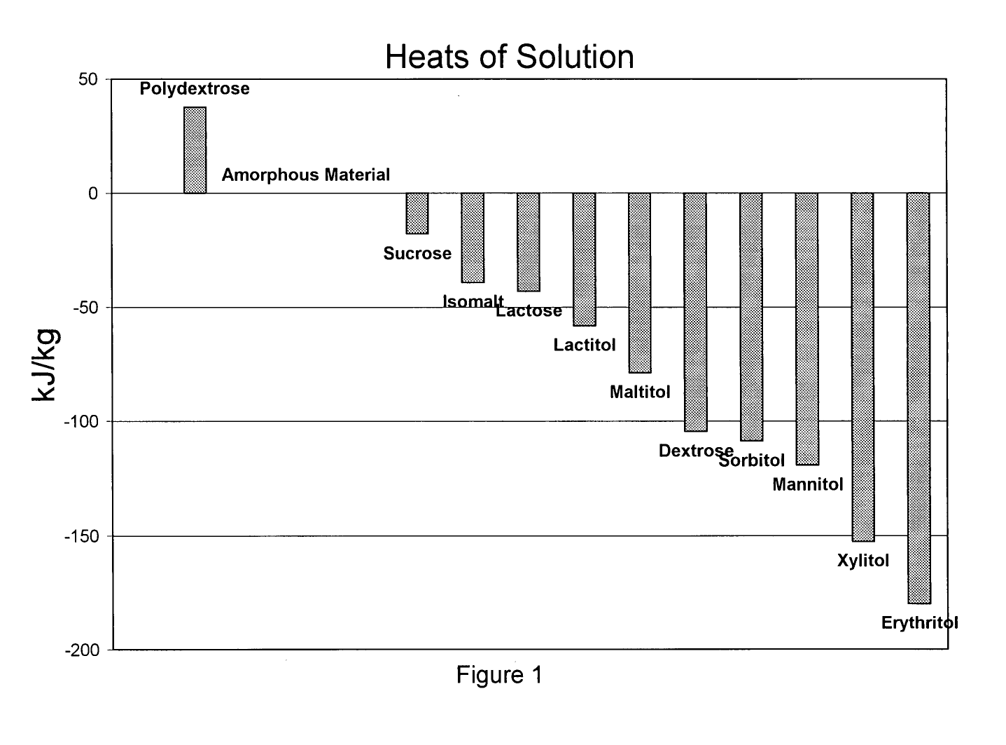

A heat of solution is the heat released or absorbed by the dissolution of a crystalline material into solution. FIG. 1 shows the heats of solution for the preferred materials according to the invention. It is believed that the difference in the heats of solution between the first region and the second region must be at least about 40 kJ/kg to obtain the desired simultaneous warming and cooling effect. Preferably the difference is about 85 kJ/kg or greater, even more preferably, the difference is greater than about 120 kJ/kg, and most preferably the difference is about 145 kJ/kg or greater, this last value being based on the difference between the heats of solution of crystalline xylitol and amorphous isomalt, which is a preferred combination. As the difference in the heats of solution increases between the two regions from 40 kJ/kg to 145 kJ/kg, the perceived thermal difference in the oral cavity is enhanced.

In many instances, the difference in heats of solution between the first region and the second region is provided by using crystalline material having a highly negative heat of solution in the first (cooling) region, and using a substantially amorphous material in the second (warming) region. It has surprisingly been found that the difference in the heats of solution between the two regions causes the amorphous region to feel warm, even though the amorphous region has a zero heat of solution and does not give off any heat while being dissolved. It would have been expected that for a material to feel warm in the oral cavity, it would have had to give off heat. However, the amorphous material does not give off heat (i.e. is not exothermic) when it dissolves.

Sugar bases (such as mixtures of sucrose and corn syrup) and sugarless bases (such as amorphous isomalt) that are conventionally used to make molded hard candies are amorphous materials. Amorphous materials do not have a heat of solution, as they are already in solution. They exist as very highly viscous solutions which are effectively solid at room temperature. As a practical matter, this means that their heat of solution is zero. As the term “heat of solution” is used herein, an amorphous material is said to have a heat of solution equal to zero.

A feature of the present invention is that one sweetener base contained in one region of said distinct and discrete regions is different from that contained in an adjacent region or regions of said distinct and discrete regions, e.g., each two adjacent regions of said distinct and discrete regions contain different sweetener bases. For example, a first region contains crystalline xylitol or other crystalline sugarless base having a highly negative heat of solution and a second region adjacent to the first region contains an amorphous sugar base or sugarless base. Alternatively, a first region of said distinct and discrete regions contains a crystalline lactitol base, and a second region adjacent to the first region contains an amorphous isomalt base. Because different sweeteners respectively have different chemical and physical properties leading to relatively different taste profiles and mouth feelings, therefore, multiple regions combined in one body portion and respectively containing different sweeteners produce variously distinctive taste profiles and mouth feelings. It is also possible to provide crystalline materials in both the first region and the second region, where there is a difference in their heats of solution of at least about 40 kJ/kg. For example, the first region could comprise crystalline erythritol, with a heat of solution of −180 kJ/kg, and the second region could comprise crystalline sucrose, with a heat of solution of −18 kJ/kg. When this product is placed in the oral cavity, the region comprising will feel cold, and the region comprising sucrose is expected to feel warm, even though crystalline sucrose has a slightly negative heat of solution. This is because of the overall difference in the heats of solution between the two regions.

As would be apparent to those of skill in the art, certain materials can be used in either a crystalline state or an amorphous state. For example, crystalline isomalt may be provided in a first region and amorphous isomalt may be provided in a second region. The first and second regions would provide a cooling and warming mouthfeel, respectively, due to the difference in their respective heats of solution. Thus, as used herein, an amorphous form and crystalline form constitute “different sweetener bases.”

According to FIG. 1, sucrose has a negative heat of solution of about 20 kJ/kg, crystalline isomalt has a negative heat of solution about of 40 kJ/kg, and xylitol has a negative heat of solution of about 157 kJ/kg. The difference in heats of solution between different sweeteners in the figure ranges from about 9 kJ/kg to about 137 kJ/kg. When different sweeteners having heats of solution that differ by more than 40 kJ/kg are combined together, distinct cooling and warming moutheels are obtained.

Preferred crystalline materials for the first (cooling) region are selected from the group consisting of crystalline xylitol, erythritol, mannitol, sorbitol, lactitol, isomalt and mixtures thereof (for the non-sugar bases), and dextrose, sucrose, maltose, lactose and mixtures thereof (for the sugar bases). Preferred amorphous materials for the second (warming) region are selected from the group consisting of amorphous isomalt, maltitol and hydrogenated starch hydrolysate (for the non-sugar bases), and sucrose, and corn syrup (for the sugar bases). As would be appreciated by one of ordinary skill in the art, “corn syrup” may include glucose syrups from sources other than corn, such as a wheat and rice.

It is also possible to provide physical warming ingredients, i.e., crystalline materials that have a positive heat of solution, such as polydextrose. Typically, such materials would not be suitable as a candy base and would likely be added to the second region to increase the effective heat of solution of that region.

The heat of solution is an intensive property, i.e., its units are per unit mass. The difference in warming or cooling mouthfeel is an extensive property, i.e., it depends on the total amount of material in the first region or the second region. If two different crystalline materials are used in a region, the heat of solution of the region will fall somewhere between the two. It is believed that the maximum difference in the sensation of warming and cooling is achieved when the surface area and the weight of the product are divided equally between the two regions, or among the multiple regions if there are more than two regions. To obtain a satisfactory simultaneous sensation of warming and cooling when one region has significantly less surface area than the other region may require a greater difference in the heats of solution between the two regions or a greater solubility level in the smaller region. Likewise, it is understood that the heats of solution listed in FIG. 1 are for pure completely crystalline material. A sugarless base may not be entirely crystalline, but still may have a significant degree of crystallinity and have a negative heat of solution. Such a confectionery material would have characteristics associated with crystalline confectionery matrices, such as being opaque and appearing grained. In this case, the material is said to be “substantially crystalline.” Likewise, a material is “substantially amorphous” even if it has some small degree of crystallinity, provided that it has amorphous characteristics such as being translucent and having a heat of solution close to zero. It is also understood that additives, such as flavorants, colorants and the like will not substantially affect the crystalline or amorphous characteristics of the region to which they are added.

Physical cooling or physical warming in the present invention results from an exothermic or endothermic dissolution of a crystalline solid material. Physical cooling or warming is distinguished from physiological cooling or warming. Physiological cooling or warming is brought about by the chemical activation of nerve receptors, such that cool and warm are sensed without there being a change in temperature.

Known physiological cooling compounds include L-menthol, N-ethyl-p-methane-3-carboxamide, N,2,3-trimethyl-2-isopropyl butanamide and monomethyl succinate. See, e.g., Parrish, M. A., “Market Warms To Physiological Coolants”, Manufacturing Chemist, pp. 31-32 (February 1987). It may be possible to provide physiological cooling compounds and/or physiological warming compounds to the first region or the second region to affect the flavor profiles of the respective regions. However, these compounds cannot be used to the exclusion of the physical coolants described herein. In fact, the use of physiological cooling and warming compounds is less preferred generally.

The inventors herein have surprisingly found that physiological cooling and warming compounds are generally not effective to produce a feeling of cooling and warming simultaneously in the oral cavity, even when used in adjacent regions. In particular, providing a confectionery product with a physiological cooling compound in a discrete region thereof does not tend to make an adjacent region feel warm to the tongue or oral cavity. Without wishing to be bound by theory, it is believed that the mechanism of physiological coolants, which relies on coating the oral cavity to activate the nerve receptors, may in some way detract from the ability to obtain the sensory effect that is achieved according to the invention.

It has been found that an exothermic dissolution and an endothermic dissolution occurring in discrete regions of an edible product will provide warming and cooling sensations, respectively, when the difference in the heats of solution is greater than about 40 kJ/kg. It is surprising that an endothermic dissolution in one region (such as when a crystalline xylitol or erythritol dissolve from one region of the product into the oral cavity) actually makes another, amorphous region feel warm.

Another feature of the invention is that the product has first and second regions having a surface on the exterior of the product, each surface being contacted by the tongue or oral cavity substantially at the same time. Within these limits, many product configurations may be considered. For example, one configuration is a hard candy small enough to easily fit inside the mouth, with just two discrete regions together comprising the entire surface area of the product. An alternative configuration is an edible having a relatively large surface area, such as a candy cane or a lollipop. In that case, at least the first and second regions should be arranged on the surface of the product so that they are contacted by the tongue or mouth at the same time. Multiple regions, each like the first and second region having a different heat of solution from its adjacent neighbor, may be provided on such a product, such that as the product is rotated or moved about in the oral cavity sensations of cooling and warming are perceived simultaneously. In another aspect, the product is an edible comprising a plurality of pieces, the first and second regions being located on separate pieces, provided that the pieces are packaged so that they contact the mouth at the same time when they are consumed. A plurality of pieces having regions with different heats of solution could also be packaged together, and such pieces could be packaged together with separate pieces having different heats of solution.

The surface area of each region of the product must be such that the region creates a sensory mouthfeel of warming or cooling distinct from another region. Therefore the first region and the second region usually each have a size no smaller than about 0.5 cm². As noted above, a lollipop may have a relatively large surface area, but the requirement that each region has a sufficient size that it creates a distinct sensory mouthfeel from its neighbor, limits the number of regions in most embodiments to a range of two to twenty, as a practical matter.

Preferably, the surface area of the first region comprises 25 to 75 percent of the total surface area of the edible product and the surface area of the second region comprises 75 to 25 percent of the total surface area of the edible product. More preferably the ratio of the surface area of the first region to the surface area of the second region is in a range of about 60:40 to 40:60. Most preferably, the ratio is about 50:50. That is, the surface area of the edible product is evenly divided between the first region and the second region.

The first region may comprise 25 to 75 percent of the weight of the edible product, and the second region may likewise comprise 75 to 25 percent of the weight of the edible product. More preferably, the weight of the first region and the weight of the second region are in a ratio in a range of 60:40 to 40:60. Most preferably, the weight of the product is about evenly divided between the two regions, and the ratio of the weight of the first region to the weight of the second region is about 50:50.

In the preferred embodiment, where the edible product is a single confectionery piece which fits in the mouth, the preferred surface area for each of the first and second regions is in a range between about 1 cm² to about 2 cm².

Apart from size, the product configuration determines how the discrete regions are distinguished in the oral cavity when the product is consumed. It is believed that the maximum effect of the difference in heat of solution between two regions is obtained when the weight and total surface area of the product are about evenly divided between the first region and the second region. Thus a product layered in a sandwich configuration, where a middle layer has limited surface area available to the tongue or oral cavity compared to the other regions, is a less preferred arrangement. Most preferably, the product is provided with a major dimension having one or more major faces, and the surface area of the regions are contiguous on a major face of the product to maximize the surface exposed to the tongue or oral cavity when the product is consumed.

In the formulation of the product, other physiologically acceptable additives, such as acids, lipids, flavors, colorants, vitamins, plant extracts, etc., can be added into the first or second region.

It may be desirable to use flavors in the first and/or the second discrete region that mimic flavors normally associated with a cool or warm mouthfeel. Thus, the first region may be flavored with flavors normally associated with cold foods such as ice cream, chilled fruit, or mint flavor; and the second region may be flavored with flavors associated with warm foods, such as pie, fudge, warmed fruit, vinegar, or toasted nut flavor. Thus a product may be designed that offers the consumer the sensation of pie a la mode, hot fudge sundae, or peaches and cream.

Now the present invention will be illustrated in detail, by the way of example only and not limitation, through the following examples of confectionery products according to embodiments of the invention.

### EXAMPLE 1

A product was made having one “warm region” and one “cool region” each having the following respective compositions, wherein the percentages are percentages by weight:

| | |
|---|---|
| WARM | COOL |

| | | | |
|---|---|---|---|
| Isomalt (2% H₂O) | 97.7% | Xylitol | 99.7% |
| Malic Acid | 2.0 | Flavoring | 0.3 |
| Sucralose | 0.02 | | |
| Colorant | 0.002 | | |
| Flavoring | 0.3 | | |

The xylitol was melted, then cooled and stirred to form a semi crystalline paste. The minor ingredients were mixed into the semi-crystalline paste. In a separate container, isomalt was dissolved in water and cooked to a very low moisture (1 to 2 percent by weight of the isomalt), and the minor ingredients were mixed in. The batch contained, before cooking 100 grams of isomalt, 30 grams water, 2.0 grams malic acid, 0.02 grams sucralose, 0.002 grams colorant and 0.3 grams flavoring). The semicrystalline xylitol paste was co-deposited with the cooked amorphous isomalt syrup in a 50:50 weight ratio into a metal hard candy mold and allowed to cool before it was removed as a lentil shaped hard candy piece. Upon cooling, the region of the resulting hard candy containing xylitol was substantially crystalline. The resulting hard candy had a surface area of about 50:50 and the ratio of surface area of the crystalline xylitol-containing region to the amorphous isomalt containing region was about 50:50. When placed in an oral cavity, the resulting hard candy created a definite mouthfeel of both warming and cooling.

Additional Examples are tabulated below. It should be noted that the No. 1 region and No. 2 region are arbitrary labels and they do not convey that either of these regions have a warming or cooling mouthfeel.

| | | Example 2 | Example 3 | Example 4 |
|---|---|---|---|---|
| Content | | (%) | (%) | (%) |
| No. 1 | Isomalt | 47.45 | 42.70 | |
| Region | Sorbitol | | | 34.90 |
| | Plant extracts | 0.10 | 6.08 | 6.00 |
| | Flavors | 1.00 | 0.02 | 0.30 |
| | Colorant | | | 0.001 |
| No. 2 | Xylitol | 42.93 | 48.79 | 42.55 |
| Region | Seeds of Xylitol | 4.63 | | |
| | Plant extracts | | | 13.50 |
| | Flavors | 0.99 | 0.01 | 0.45 |
| | Colorant | 0.001 | 0.001 | |

| | | | |
|---|---|---|---|
| Moisture and others | 2.90 | 2.40 | 2.30 |

### EXAMPLE 2

In Example 2 as illustrated in the above list, a hard candy comprises a first region containing 47.45% by weight of isomalt, 0.10% by weight of extracts of plants, and 1.00% by weight of flavors, and a second region containing 47.56% by weight of xylitol, 0.99% by weight of flavours and 0.001% by weight of colorant, and 2.90% by weight of moisture and other additives. The manufacture of the hard candy includes following steps: (1) first in a dissolving step, isomalt and xylitol are separately dissolved to be prepared as base materials; (2) second in a mixing step, plant extracts and flavors are respectively added in and mixed with the isomalt base, and the xylitol base; (3) third in a forming step, firstly, a first region is formed with the isomalt base, then a second region is formed with the xylitol base and integrated with the first region on an upper/outer surface of the first region; (4) fourth in a cooling and solidification step, after a period of time, the bases of the first and second regions being formed in sequence are cooled and solidified simultaneously, to form an integrated hard candy.

In this example, the hard candy comprises two distinct and discrete regions including first and second regions of approximate equal size. The body portion of one hard candy comprises two distinct and discrete regions, which respectively have different mouth feelings and taste profiles due to the different chemical and physical properties of the different sweetener bases respectively contained in the first and second regions. The first region has a characteristic taste profile and nutrient value that is different from that of the second region by adding plant extracts into the first regions. The first and second regions are respectively added with different flavors, which also increase the taste distinction between the two regions. Particularly, the second region is treated by adding crystal seeds of xylitol to promote the growth of small crystal grain size, thereby the finenesses of the first and second regions are varied, so as to improve the mouth feeling. In addition, colorant is added in the second region to improve the aesthetic appearance of the product in order to attract consumers.

### EXAMPLE 3

In Example 3, a hard candy comprises a first region containing 42.70% by weight of isomalt, 6.80% by weight of extracts of plants, and 0.02% by weight of flavors, and a second region containing 48.79% by weight of xylitol, 0.01% by weight of flavors and 0.001% by weight of colorant, and 2.40% by weight of moisture and other additives. The manufacture of the hard candy of Example 3 is similar to that of Example 2, however, the composition and taste profiles of the candy of Example 3 are different from that of the candy of Example 2.

### EXAMPLE 4

The composition of the candy of Example 4 is different from the composition of the candies in Example 2 and Example 3. In this Example, the candy comprises a first region containing 34.90% by weight of sorbitol, 6.0% by weight of plant extracts, 0.03% by weight of flavors, and 0.001 by weight of colorant, a second region containing 42.55% by weight of xylitol, 13.50% by weight of plant extracts, 0.45% by weight of flavours, and 2.30% by weight of moisture and other additives. The manufacture of Example 4 is similar to that of Examples 2 and 3, however, the composition and taste profiles of the candy of Example 4 is different from that of Examples 2 and 3.

The confectionery product according to the present invention may comprise more then two regions. For example, the confectionery products may include three regions consisting of two xylitol based regions and one isomalt based region sandwiched there-between, or alternatively, containing three different sweetener bases, for example, isomalt base, xylitol base and sorbitol base, or alternatively, any other combinations of three different sweetener bases.

Overall, the present invention provides an edible product, which comprises multiple distinct and discrete regions, each two adjacent regions respectively containing different sweetener bases. Different sweeteners respectively provide different mouthfeeling due to their different heat of solution, therefore the distinct and discrete regions of the product provide a simultaneous sensation of cooling and warming.

1. A rigid edible product, comprising at least a first region and a second region,
wherein the first region and the second region each has a surface on the exterior of the product such that they are both contacted substantially simultaneously by the tongue or oral cavity when the product is consumed;
wherein the first region and the second region are each discrete and sufficiently large that they each provide a discernible sensory mouthfeel of warming or cooling;
there being a difference in the heats of solution between the first region and the second region of 40 kJ/kg or greater.

2. The edible product according to claim 1, comprising a single edible piece, wherein a surface area of the first region and a surface area of the second region are contiguous on the exterior of the product.

3. The edible product according to claim 1, comprising a single edible piece having a major face, wherein the surface area of the first region and the surface area of the second region are laterally adjacent on the major face of the edible piece.

4. The edible product according to claim 1, comprising a single edible piece consisting of two to twenty discrete regions.

5. The edible product according to claim 1, comprising a plurality of edible pieces, the first region and the second region being located on separate pieces, the pieces being packaged so that pieces having the first region and pieces having the second region are simultaneously contacted by the mouth when the product is consumed.

6. The edible product according to claim 1, wherein the first region comprises 25 to 75 percent by weight of the edible product and the second region comprises 75 to 25 percent by weight of the edible product.

7. The edible product according to claim 1, wherein the surface area of the first region comprises 25 to 75 percent of the total surface area of the edible product and the surface area of the second region comprises 75 to 25 percent of the total surface area of the edible product.

8. The edible product of claim 1, wherein:
the first region is substantially crystalline and has a negative heat of solution and produces a cooling sensory attribute on the tongue or in the oral cavity; and wherein
the second region is substantially amorphous having a heat of solution of about zero, such that a difference in the heat of solution between the first and the second region is at least about 40 kJ/kg.

9. The edible product of claim 8, wherein:
the first region comprises a sweetener base selected from the group consisting of crystalline xylitol, erythritol, mannitol, sorbitol, lactitol, isomalt, dextrose, sucrose, lactose and mixtures thereof; and wherein
the second region comprises a sweetener base selected from the group consisting of amorphous isomalt, maltitol, sucrose, corn syrup, hydrogenated starch hydrolysate, and mixtures thereof.

10. The edible product of claim 1, wherein the edible product is a hard candy confectionery.

11. The edible product of claim 1, wherein the edible product is a pressed tablet.

12. The edible product of claim 1, wherein the first and second region each has a surface area on the exterior of the product of at least about 0.5 cm .

13. A hard candy edible product, comprising
a first discrete region having a surface area on the exterior of the product, containing substantially crystalline xylitol and having a first heat of solution;
a second discrete region having a surface area on the exterior of the product, separate from said first region, containing amorphous isomalt and having substantially zero heat of solution;
wherein the difference between the first heat of solution and the second heat of solution is at least about 145 kJ/kg.

14. A confectionery product comprising an integrated body portion, which includes at least two distinct and discrete regions, wherein said distinct and discrete regions respectively contain acceptable sweetener bases, each two adjacent regions respectively contain different sweetener bases, and at least one region of the sweetener bases essentially contains sugar free sweetener bases, said distinct and discrete regions being adapted to provide multiple different mouthfeels of warm and cool.

15. An edible product kit, comprising a plurality of separate edible pieces, said plurality of edible pieces packaged so that at least a first piece and a second piece are contacted substantially simultaneously in the oral cavity, wherein said first piece and said second piece comprise different sweetener bases, there being a difference in the heats of solution between the first piece and the second piece of 40 kJ/kg or greater.
